(19) United States
(12) Patent Application Publication
(10) Pub. No.: US 2024/0193625 A1
(43) Pub. Date: Jun. 13, 2024

(54) Consumer Goods Sampling and Retail Vending Device

(71) Applicant: FERNANDO MACHIN GOJDYCZ, Houston, TX (US)

(72) Inventor: FERNANDO MACHIN GOJDYCZ, Houston, TX (US)

(21) Appl. No.: 18/523,854

(22) Filed: Nov. 29, 2023

Related U.S. Application Data
(60) Provisional application No. 63/385,270, filed on Nov. 29, 2022.

(51) Int. Cl. G06Q 30/0201

(52) U.S. Cl. CPC G06Q 30/0201

(57) ABSTRACT

A retail and marketing device, method and systems for interfacing consumers, brands and/or retailers to assist in determining consumer preferences and purchasing patterns in order to understand purchasing intent and conversion. The device is directed to an automated, touchscreen or touchless interface, which can include integrated smartphone technology, coupled with a product sampling and product dispensing devices, utilizing a direct consumer interface, whereby artificial intelligence (“AI”), machine learning, gamification, and/or rewards systems may all be incorporated and used to enhance consumer sampling and product interactions and experiences, optionally coupled with the ability to offer advertising services and consumer-specific data to retailers, brands, vendors and product manufacturers.

### REFERENCE TO RELATED PATENTS

The present application claims priority to the previously filed provisional application No. 63/385,270 filed Nov. 29, 2022.

### FIELD OF THE INVENTION

The present invention relates generally to an automated internet-of-things (“IoT”) retail and marketing device or devices, methods and systems for interfacing consumers, brands and/or retailers (vendors) to assist in determining consumer preferences and purchasing patterns in order to understand, for instance, purchasing intent and conversion and/or link marketing dollars with directed consumer profiles and key-performance indicators (“KPIs”). Specifically, in example embodiments, the disclosed devices, methods and systems may be directed to an automated, touchscreen or touchless interface, which can include integrated smartphone technology, coupled with a product sampling and product dispensing device or devices, utilizing a direct consumer interface, whereby artificial intelligence (“AI”), machine learning, gamification, and/or rewards systems may all be incorporated and used, in coordination, to enhance consumer sampling and product interactions and experiences, optionally coupled with the ability to offer advertising services and consumer-specific data to retailers, brands, vendors and product manufacturers.

### BACKGROUND

Traditional “vending” machines are very large, homogeneous and do not offer advertising and data collection services to product providers, companies (e.g., retailers, marketers, and vendors) or third-party collection organizations while offering to consumers the opportunity to experience specifically advertised and marketed products through said machines, nor offer gamification experiences, associated with such advertising and data collection services. Additionally, current technology in the field of vending machine field lacks AI, machine learning, and loyalty systems for consumers utilizing such “vending” machines, which allows for the dispensing of coupons, points, product samples, full-sized products or a combination thereof. Moreover, current state-of-the-art vending machines, themselves, are not leveraged to utilize information and data gathering techniques to acquire knowledge and/or insight as to the preferences and/or consumer profile of a user, whether typical or atypical. And while the disclosed technology allows for determining consumer preferences and proclivities, in efforts, for example, to enhance consumer experience, this same technology may provide manufacturers and/or retailers with specific and directed insights into consumer purchasing data, whether simultaneously to a vending-machine transaction, near real time, or thereafter, to determine and/or measure user engagement, monitor consumer activity, determine return on investment (“ROI”), to create brand awareness/recognition, and/or to understand purchasing power which is quantifiable demographically.

The present invention describes and discloses devices, methods, and systems, which may improve the consumer's experience with relation to product dispensing modules via product sampling, product dispensation, consumer information gathering, and/or gamification, where machine learning may further permit companies to promote and offer directed services and goods to customers based on customer-specific interactions with a “product” dispensing device. Specifically, the present invention's “product” may be defined as a (physical) tangible item (i.e., including, but not limited to, a consumable sample, a consumable, and/or a cosmetic), an intangible item (i.e., including, but not limited to, a discount code, loyalty points, a pre-paid phone card, or a combination thereof) or some form of transferable “product” (i.e., including, but not limited to, a donation, transmittal of funding, a payment or some combination thereof).

Distinctively, the disclosed device(s), methods, and system(s) may allow for a non-conventional interaction between manufacturers and consumers (and consumers and manufacturers) wherein manufacturers, retailers and vendors may be allowed innovative ways and approaches to advertise and attract new consumers and, by the same token, consumers may be provided with a new experiential involvement by which the consumer may interact with a source of products and/or the products themselves. Further, as a result of the consumer-module interaction, the manufacturer may gain insightful knowledge of the consumer, in terms of preferences, patterns, proclivities, etc., as to better meet the needs of existing customers as well as gain new customers.

Too, information gathered from the above interaction may be monitored, gathered, analyzed, and/or processed to (1) detect patterns from the collected data consumer preferences, (2) provide a satisfying experiential interaction through products from specific vendors, (3) augment or modify the data gathering process through a continual feed-back loop to more efficiently determine consumer preferences, (4) to anticipate product performance based on collected data and/or (5) better tailor product manufacturing, availability, type and quantity to consumer wants and needs—all based on direct and indirect data collection from consumer-module interactions.

While strides have been made to overcome the inadequacies of currently available dispensing machines and systems, it remains evident that considerable failings remain in the art and multiple failures exist in terms of functionality. It is in light of the above shortcomings that inventor seeks to remediate the deficiencies in the field and address the long felt need for a consumer-centric dispensing module that serves the needs of both product and services suppliers and end user consumers.

While inventor has set forth the best mode or modes presently contemplated of carrying out the invention known to the inventor such to enable a person skilled in the art to practice the present invention, the preferred embodiments are, however, not intended to be limiting, but, on the contrary, 5 are included in a non-limiting sense apt to certain alterations and modifications within the scope and spirit of the disclosure and appended claims.

### SUMMARY

In one embodiment, disclosed is an interactive, touchscreen-enabled dispensing module implemented (a) via a kiosk or stand-alone structure (b) within an existing retail location, grocery store, department store, venue, or (c) external to a building or structure wherein said system contains logic, whether reduced to hardware and/or software, e.g., algorithms, which may enhance a consumer's shopping experience by the usage of AI, machine learning, and/or loyalty experience systems, while optionally offering directed marketing and advertising services to consumers of brands from the perspective of manufacturers, vendors and/or retailers. This service may include, but is not limited to, dispensing of tangible products (e.g., physical “sample” products, “full-sized” products, intangible products (e.g., codes, discounts, points, minutes), transferable products (e.g., donations or other funds transfer), all while also facilitating acquisition of consumer demographic information, acquisition of consumer preferences, via direct data gathering, indirect data gathering, gamification of interactions between the device and consumer, inventory monitoring, automated sales transactions, and the like. These consumer experiences, which may intake consumer's inputs and may output desired or recommended good(s) and/or service(s) through the use of AI, machine learning, algorithms, and data-driven technology, which are leveraged to allow the consumer to receive desired samples, products, goods (e.g., various sundries and/or electronics), and/or services (e.g., mobile phone minutes, game points, discounts or coupons for products) and, in turn, a supplying manufacturer, vendor, retailer or third-party processor or vendor receives customer information and data (e.g., age, demographic, location, preferences, etc.), which may be either direct information gathering (data supplied via consumer inputs) or indirect information gathering (based on payment information, location of a module, choice of product or sample, or gamification recorded responses), or a combination of both direct and indirect information.

### BRIEF DESCRIPTION OF THE DRAWINGS

Advantages and other aspects of the invention will be readily appreciated by those having skill in the art and may be better understood with further reference to the accompanying drawings in which like reference numbers designate like or similar elements throughout the several figures of the drawings and wherein:

The detailed description refers to the following drawings, in which like numerals refer to like objects, and in which:

FIG. 1 illustrates an exploded view of the present invention that is a module for consumer-to-module interaction;

FIG. 2a shows a front, side and wireframe view of the inventory mechanism of the present invention;

FIG. 2b shows an operational arm of the inventory mechanism of FIG. 2a.

FIG. 3 illustrates an example system for gathering, collecting and processing information as a result of a consumer-module interaction according to this disclosure; and

FIG. 4 illustrates an example of the system in FIG. 3 with greater detail.

It should, however, be understood that the above figures and summary are not intended to limit the invention to any particular embodiment disclosed, but on the contrary, the invention disclosure is intended to cover all modifications, alternatives and equivalents falling within the spirit and scope of the invention as defined within the claim's broadest reasonable interpretation consistent with the specification.

### DETAILED DESCRIPTION

A detailed description of the preferred embodiments of the invention are disclosed and described below. Yet, each and every possible dimension, arrangement and configuration, within the limits of the specification, are not disclosed as various permutations are contemplated to be in the purview of those persons having skill in the art. It is therefore possible for those that have skill in the art to practice the disclosed invention while observing that certain features and spatial arrangements are relative and capable of being amended and adapted with regard to the present invention that nonetheless accomplishes the remediation of one or more of the infirmities as outlined and discussed above in the field of two-way communications between consumer and module and use within a single dispensing module. As well, the module, and its components, may be sized (i.e., enlarged or shrunken) so long as the proportions are maintained that allow for maintaining and proper functioning toward dispensing products or services.

Equally, it should be observed that the present invention can be understood, in terms of both structure and function, from the accompanying disclosure as well as claims taken in context with the associated drawings. And whereas the present invention and method of use are capable of several different embodiments, permutations, and varied uses, which can be modified into several different iterations, each exhibiting accompanying interchangeable functionalities without departing from the scope and spirit of the present application as shown and described.

Disclosed are devices, methods, and systems comprising data driven technology that may include logic, e.g., hardware module(s), software module(s) and/or firmware, or a combination thereof, hereinafter (the “dispenser machine” or “module”), that is located remotely (i.e., cloud based), locally (within a “module), or a combination thereof, that may be capable of interfacing consumers, manufacturers and retailers via an integrated matrix, wherein consumers and/or suppliers may positively affect consumer interactions and experiences. This process may be further facilitated by a third party intermediary who may receive and collect data, including, but not limited to, further data gathering, data collection, data storage, data processing, and data monitoring in order to (a) enhance the user (consumer) experience, regulate inventory, modify data gathering, enhance direct or indirect data gathering, accept and institute monitorable parameters from the vendors/manufacturers/retailers or other the third-party services and/or implement the directives of vendors/manufacturers/retailers as to more efficiently implement the requirements of the vendors/manufacturers/retailers services by the third party. Too, this method and system may be comprised of a non-transitory program storage device comprising instructions stored thereon to effectuate the above procedures.

### Hardware

A vending or dispensing device (“dispenser machine” or “module”), optionally remotely controlled and/or commanded by an operator, comprising or consisting of a dispenser machine (module) and dispenser machine network operated by system owner (or licensor that may be operated for the benefit of a licensee).

Said device preferably has the dimensions of approximately 85 cm×65 cm×22 cm but may be variable based on products or location requirements (e.g., the device itself may be configured to occupy a shelf space, said device may be a floor unit and/or configurable to suit any dimension as to accommodate a receiving space or products therein).

The dispenser machine may further be configured to control dispensing of one product from one or a plurality of products (from one many different products) per dispensing module.

The dispenser machine (module) may be configured to provide samples and/or sell and/or provide different goods and services of mass consumption through credit cards (or others means of electronic payment) or through bill or coin acceptance (i.e., fungible tokens). Of note, the actual “product” dispensed may be for immediate consumption or to facilitate a future transaction (e.g., the provision of a card or code for points) or as a donation or gift. Where this future transaction is provided, the consumer, after playing a game, providing contact information, or providing payment, or otherwise, may be given a card (or displayed a QR code) for use on the manufacturer's website or in a manufacturer's store.

The disclosed device or devices, methods and systems may include at least one touchscreen monitor interface device (Graphic User Interface or “GUI), preferably greater than or equal to six (6) inches, or a touchless system, that may allow for a verbal or visual exchange or a means for the consumer to interact via consumer's mobile phone (through a scan or displayed QR code which directs the consumer to a mobile device application or URL) for continued interaction. Moreover, the user/consumer may continue the interaction via the former operation or operations to provide direct data, play a game or provide payment. The monitor may instead or also include at least one standard non-touchscreen Graphical User Interface (GUI) for module-consumer/user interaction.

The disclosed devices, methods and systems may include at least one (1) to a plurality of cartridges, which may be removable or not, and may be substituted by bigger or smaller cartridges depending on product size for containing and holding a tangible product.

Additionally and alternatively, the module may contain no tangible products and may only provide a non-tangible product (e.g., a code or codes, points or rewards) or, in the case of a donation (in the case that the module is contained within a place of worship, a zoo, or like facility) or transfer of funds, points, rewards or other assets to friends, family or to various locations worldwide for relief (e.g., in the case of a natural or man-made disaster).

Additionally and alternatively, the disclosed devices, methods and systems may include: infrared sensors inside the dispenser that may detect product stock and/or product dispensing comprising:
a front camera and human presence sensor;
a speaker and microphone for audio projection and intake;
one (1) motor or a plurality of motors per cartridge;
one (1) spiral per cartridge; and/or
two (2) central controller devices in electronic communication with each other, wherein
Controller 1: in charge of high-level abstraction layer and graphic interface managing; and
Controller 2: in charge of low-level abstraction layer; managing motors, infrared sensors, and coin/bill acceptors.

Additionally and alternatively, sales and/or transactions may be monitored on a transaction-by-transaction basis, where each dispensing of a sample product or sale of product (and or provided service) “registers” with an internal system (e.g. a processor) that then may communicate the sale or service information wired and/or wirelessly through a controller and telecommunications conduit (e.g., Wi-Fi®, Bluetooth® and the like). Inventory may then be tracked and measured through internal monitoring mechanisms or as a result of sales wherein each sale is reflected in a deduction in inventory and monitored through “dispensing” (samples delivery or products sales).

### Software Module(s)

### Cartridge Database Module

Cartridge database(s) may hold information of each product and its correspondence to each cartridge/motor. The database(s) may contain product dimensions, product quantity, product price, product identifier, product name, and/or other information about the products.

### Product Selection Module

Controller 1, for example, may be responsible for and capable of displaying on the graphical interface or the touchscreen, an image for each product, which is contained inside the dispenser. When the user selects, through the touch screen, one or multiple products, Controller 1 may identify the particular product to be dispensed, as a product image is associated with the product identifier through the cartridge database module and gives the instruction to dispense that product to the consumer/user triggering a dispensing and “fall” detection module.

When the corresponding infrared sensor detects there is no stock of a particular product or product type, Controller 2 may send an “out-of-stock” message to Controller 1, which in turn may result in audio, visual, or audiovisual display of an out-of-stock message on the graphic interface and may disable the selection of that particular product. Each time a product or sample is dispensed from the cartridge, a signal may be sent through the system to the vendor (or third party) responsible for refilling the machine as a notice to refill the module. This may allow the system to track the inventory quantity and may allow the AI and/or machine learning to analyze the data alongside environmental events, which may be taking place at the location of the dispenser, to inform the vendor when to refill the cartridges, rather than waiting until a specific quantity remains. Alternatively, a threshold may be set wherein a notification is sent to a vendor or third party indicating that stock is “low” and a “refill” is imminently required.

The description of this module is described in explanation as an example preferred embodiment but is not a limitation of the scope of the devices, methods, and systems for other embodiments therefore.

### Payment Processor Module Device Comprising for Example:

After a product or service is selected, a user may proceed with payment or may supply information directly or indirectly, such as through a gamification module. This can be accomplished, for example, in the following ways: cash, debit/credit card, digital currency, or alternative electronic forms of payment.

### Cash

In one example preferred embodiment in a case of paying with a fungible token (i.e., cash or coin), Controller 1 may display on the graphic interface the product's cost of purchase amount. The user then may proceed to insert the coin/bill in the correspondent input device, which may send a signal with the amount inserted to Controller 2. Controller 2 then may send instruction to Controller 1, which may update the amount on the GUI on the touchscreen. Among other functions, a payment processor module may compare the amount inserted with the product price given by the cartridge database module.

If the amount of fungible token input by the user is equal to or greater than the product's cost of purchase, the payment processor module gives the product dispensing module the instruction to dispense the product.

If the amount of cash input by the user is greater than the product's cost of purchase, then the payment processor module will dispense the appropriate change to the user, i.e., the difference between the amount inputted by the user and the product's cost of purchase or credit the user's preferred form of payment.

### Debit/Credit, or Other Electronic Forms of Payment

In case of paying with debit/credit card or other electronic forms of payment, the user may provide the payment to the correspondent device, which processes the payment of the amount given by the product price in the cartridge database module. Once payment is accepted, the payment processor module gives the product dispensing module the instruction to dispense the product.

In another embodiment, the user can pay using a virtual wallet, cryptocurrency, through redeeming reward points, or any other method deemed viable for payment.

### Product or Service Dispensing Module

After the payment processor module sends the instruction to product dispense module, Controller 1 sends a message to Controller 2 to activate the correspondent motor through product identifier, wherein the enabling logic for this sending, activating, and other method functions disclosed herein are accomplished through software, hardware, and/or combination thereof located remotely, locally, or combination thereof to the function. When the motor is activated, the spiral, for instance, that is located in the product dispensing device, rotates moving the product to the end of the cartridge. When the product falls/drops, the corresponding infrared sensor sends a signal to Controller 2, which detects variation in velocity and deactivates the motor. Controller 2 then sends a product dispensed confirmation message to Controller 1, which then displays a message to the user on the graphic interface.

### Gesture Recognition (Webcam) Module

The disclosed devices, methods and systems may be able to recognize consumer gesture(s), and change abruptly through this recognition, as means of consumer's interaction with the dispenser. This logic enhances the user experience by making the experience more personal or otherwise attractive for the consumer.

In one example embodiment, the camera may send image sequence (video) to Controller 1, which applies gesture recognition algorithms to the received images. Depending on the gesture detected, Controller 1 changes graphics and/or text information displayed on the graphic interface or may give instruction to dispense a particular product through the product selection module.

More explicitly, a touchless interaction may be conducted through hand motions wherein answers to questions may be answered by gestures or indications made by consumers through overt signaling of hands in a direction of a response (i.e., up, down, left, right or to various quadrants or locations about a device or touchpad).

In another embodiment, the device, method and system may recognize that the consumer is placed in the center of a three (3) by three (3) (3×3) grid, labeling the top left space of the grid one (1) then going left to right filing in the remaining spaces with a number, before moving to the next line to identify the remaining spaces as it work left to right, top down. The device, method and system may recognize hand motions or body movement to other spaces in the grid. For example, a person centered on the grid will fill up space two (2), five (5), and eight (8), and when prompted to make a selection with two (2) choices will need to reach either their left or right hand to space one (1) or three (3).

In another embodiment, the grid can contain more spaces and the consumer may need to move parts of their body to different spaces in order to make selections.

In another embodiment, the consumer can make simple hand gestures, such as pointing towards the dispenser and making a clockwise, counterclockwise, up and down, left or right motion.

In another embodiment, the consumer can hold up a finger to a plurality of fingers to make a selection.

In another embodiment, the consumer may be required to hold up an item for recognition, sensing or scanning in order to provide a product that is within the module.

### Human Presence Detection Module

Human presence detection makes it possible to interact with the consumer or a potential consumer who approaches the dispenser.

Human presence sensor, in front of the dispenser, sends a signal to Controller 2, when there is a human nearby the dispenser. Controller 2 sends a message to Controller 1, which may process the information and respond with a graphical distinctive manner on the screen. For example:
a) turning on the screen;
b) changing screen brightness to optimal level depending on environment;
c) graphical animations; or
d) direct interactions with a potential consumer or customer.

This function may attract potential nearby consumers to approach and interact with the dispensing machine, which, itself, may be qualified by “sleep/standby” modes and “awake/active” modes as dictated by a consumer's presence or activity.

### Audio Recognition Detection Module

The present device, devices, methods and systems may be able to use voice recognition as means of consumer's interaction with the dispenser. This may enhance the user experience making it more personal or otherwise attractive for the consumer.

When the user approaches/uses the device, methods and systems, the user may begin making selections and/or input using the audio intake system built into the dispenser or connected thereto.

In one embodiment, the user calls a number prompted by the device/system and enters in a temporary code to connect to the device/system and relay information back and forth between user/consumer and module.

In another embodiment, the user scans a QR code on the screen associated with the device/system and either accesses a mobile phone application (“app”) or is prompted to a webpage for the duration of the interaction to connect and receive, send, or exchange information with the consumer or a consumer's device in communication (e.g., wirelessly, Bluetooth®, etc. with the product dispenser).

In yet another embodiment, a visual presence detection and audio recognition detection mode or module may be used together, simultaneously, sequentially, in tandem, reciprocally, or a combination thereof, to determine consumer selections.

### Gamification and Loyalty System Module

Gamification modules may enhance a consumer's experience in that participation in data collection is made attractive through the implementation of a task or series of tasks, which result in achieving a goal or winning a game. The attractive nature of a gamification module appeals to potential consumers who are drawn to the possibility of winning a product, obtaining discounts, and/or accumulating rewards or reward points for products or services acquisition(s).

The disclosed devices, methods and systems may include an interaction module for registration purposes, which may attract user registration through economic incentives, such as discounts, points, rewards, acquisition of free products, or a combination thereof. As a result of the consumer registering an account with the module, the consumer's demographic data, habits and preferences can be readily identified, directly, indirectly, or a combination thereof.

Potential consumers are invited to play a game in order to access product samples, tokens, points, rewards or for discounts towards the purchase of products sold in the dispenser, including the possibility of receiving a product sample or service at no cost. This interaction module may include a touch-screen display, webcam detection, and/or audio recognition (described above) with games such as: puzzles, memory games, trivia, word and picture associations featuring companies, brands, sports teams and the like.

When a user obtains a sample, prize or a discount, the gamification module may instruct the processor module to dispense a particular product or a “free” ticket, card or a displayed QR code for a discount or a service.

In the case of a card, a physical card may be dispensed, or, in the case of a code, a QR code may be scannable by the consumer to receive a discount, coupon, reward or points. The same QR code may provide information to the consumer to register with a manufacturer or retailer in order to receive the coupon, discount or points.

Using gestures and QR codes, the entire interaction may be “touchless”. Importantly, the device/system may be able to gain information at the point of the first interaction and upon registration and subsequent interactions (as detailed below).

As a registered consumer (user) plays games, interacts with the dispenser, and/or obtains a product or a service from any dispenser machine (module) of the network, the current device and/or system may credit rewards for discounts/points/goods to consumer. The consumer's interaction and experience information are transmitted to the system and stored to monitor the consumer's experience and this information may be utilized to credit rewards.

In one embodiment, when a predetermined number of rewards has been obtained by a user, an instruction for dispensing a product or service by “cashing in” the user's rewards may be sent to a processor, optionally for further processing.

Rewards may also be deferred and saved by the user for future use. An accumulation of rewards allows the user to trade in at a future use for products or services.

### User Registration

When a consumer interfaces with a dispenser, the Consumer may be prompted with the following options: (1) Create a User profile; (2) Login; and/or (3) Continue as a guest.

### Registering as a User

As a first time or subsequent user, the user may have the choice of registering as a new user of the dispenser. The consumer may register a profile with the device/system in the following ways, for example: (1) QR code shown on the graphic interface which directs user's cellphone through an application service that completes the registration process through Whatsapp®, Facebook®, Google® and other means of social identification to be offered to and then selected by consumer; (2) e-mail registration; (3) cell phone registration; (4) mobile application; (5) facial recognition; or (6) direction to a URL any other methods facilitating interaction.

Once registration is completed, the user can choose to login to the device/system and update users account profile. User can provide any information user wants and may have the option to obtain a physical RFID or virtual card to allow the user to login into the dispenser during future use or uses, to gain more points/coupons or to obtain additional products.

### Logging in as a Registered User

Upon interacting with a dispenser, a registered user may be able to log in to the device/system in the following ways, for example: (1) QR code shown on the graphic interface which directs user's cellphone through an application service that completes the registration process through Whatsapp®, Facebook®, Google® and other means of social identification to be offered to and selected by consumer; (2) e-mail; (3) cell phone number; (4) mobile application; (5) facial recognition; (6) RFID membership card; (7) virtual wallet card; or (8) direction to a URL or any other methods.

### Continue as a Guest

A consumer may have the choice to interact with the device/system and obtain products and services but may forfeit potential awards if the consumer proceeds as a guest.

### User Data Acquisition and Processing Module

When a user interacts with the device/system, any information collected may be sent to the user database, which may be connected to the dispenser system network through wire, wirelessly, or via other technology. User's data may be stored in one or more databases and used to identify the user in future purchases as well as recommend and offer products, which may suit the user's preferences. The collection and data processing activities may be retained by the dispenser system/device, and user may have the option to customize and adopt privacy preferences by design standards and state-of-art principles dependent upon rules, regulations or user preferences.

Each time a logged-in user makes a purchase, selection, answers a question, or plays, wins or loses a game on the dispenser, this information may be uploaded to the user database and/or other databases in association with the disclosed devices, methods and systems.

Thereafter, when a user logs into the device/system, depending on the information about that particular user in the user database, Controller 1 may display, whether audially, visually, or combination thereof, different messages on graphic interface and/or speaks in association with the disclosed devices, methods and systems either directly related to the user's profile or agnostic to the user.

Based on data collection, the device/system can customize the interaction with the user in a variety of ways, such as sending visual or audio greeting, congratulatory, or thank you messages during the user's interaction, whether it be when the user logs in, during the use, or at the end of the interaction. The device/system also has the capability to call attention to the consumer by reading aloud the user's name.

Personal data obtained through the dispenser's network system and processed through the system, may be transferred from the dispenser network system operator (optionally with registrants' or guests' consent, adequately obtained through dispenser or outsourced) to brand companies or interested and disclosed parties operating through the dispenser network, respecting data privacy legislation, adopting privacy by design specific consent, and making available to consumer data privacy rights to accept or reject.

In one embodiment, enabling logic, such as through hardware and/or software, e.g., algorithm(s), may be utilized, taking into consideration the location of the dispensing device, to ask a series of questions as to determine gender, age, socioeconomics, demographic information, purchasing preferences, consumer proclivities, or a combination thereof as to better define “who” the consumer is. This information may be agnostic or individually based, wherein those questions directed to an unidentified consumer may be general fact-gathering questions, taking location of the device into context, or those having identifying information (phone, email, social media information) may be directed questions, or a combination of both general and specific questions, which are direct inquisitions or gamified. Information may be subsequently gathered in the case of an unidentified consumer or consumers which subsequently remain unidentified or becomes identified (e.g., where a discount, reward or points require identification prior to access).

Where information is gamified, questions may be indirect where the answers indicate the consumer's classification (e.g., GenX v. GenZ, male or female, urban-residents v. rural residents, and the like) which are not directly asked for the identifying classifications but are gathered as indirect questioning of the user. Conversely, gamification questions may be direct and explicitly ask age, gender and preference. The questions posed an identified or unidentified consumer may be a combination of explicit and non-direct questions as to better determine the age, sex, demographic, socio-economics or other identifying indicia material to a manufacturer or retailer as to better define an individual, groups of individuals, groups of groups, or a combination thereof, spanning selected individuals all the way to metadata.

### Artificial Intelligence and Machine Learning Module

Data collected through the user's interaction with the module can be processed by the device/system optionally with machine-learning algorithms, for example, that may allow the possibility to apply targeted marketing strategies to the user or other users.

The disclosed methods, devices, and systems may detect specific product or service selection made by the user and/or user's consumption of a specific product or service and process such data in order to learn about user's behavior, demographics, personality, preferences, and/or otherwise. Using this information, the AI and machine learning module can give instructions to the processor in order to offer the user products, services, special discounts, games, advertisements or other recommended suggestions for the user.

The disclosed methods, devices, and systems may cross-reference personal data obtained through different dispenser machines and across various users, which then may be processed by the dispenser machine (module) network in order to further offer customized preferences to the user or other users. The purpose is twofold, wherein the device/system may also utilize external data provided to the device/system about the user or users to further provide customized preferences and enhance the user expedience, by, for example, offering products, services, special discounts, games, advertisements or other recommended suggestions for the user based on direct or indirect data gathering.

By further example, the user, such as in a previous interaction disclosed, that the user prefers shower gel as opposed to a bar of soap. Knowing that user's preferences, then when that user uses a new dispenser having communication with stored or otherwise accessible user data, the new dispenser can provide a sample to the user for a new bath gel, which it could not do previously because either the previous dispenser was out of the product or the previous dispenser never carried the product in the first place and asked the question for an alternative reason. Moreover, the user, by providing direct and indirect information to the module (and thus all modules), may be pre-identified, categorized or preferentially selected as belonging to a specific group or demographic on an ongoing basis wherein each information or data piece allows the machine learning or AI module to further define and delineate the user. Thereby, with each piece of gathered data (e.g., location, preferences, likes, area code, gender and the like) the module may be able to preselect each next question or piece of gathered data as to further define the likely preferences of the user and to categorize said user.

The system may communicate related discounts or promotions through the touch screen display, via Bluetooth® or WiFi® communications with a consumer's device or auditorily, at the moment the device/system identifies, i.e., recognized and optionally verifies, the consumer, and through notifications or communications sent to the user via any available means of communication external to the dispenser machine, such as email or text messages.

User and Vendor Interactions with the Dispenser

Vendors may include companies, manufacturers, retailers and other product offering or service providing organizations, which may sell goods and services and may or may not have established branding that is recognizable to a consumer. Vendors may be able to provide free samples or sell goods and services to users who interact with the module. If a user consents to sharing their information or the information is shareable by default or otherwise, then the information may be used to help recommend different products or services, which may be suitable to the user or provide further opportunities to the user.

In one embodiment, the user may approach the module and may be prompted with several questions, such as gender, age range, favorite type of music, and whether they like chocolate or fruit. If the user states user likes county music more than rap music, then the user, for example, may be presented with a card with a QR code or link to music vendor, such as Apple Music or Amazon Prime, to redeem for a country song, explore a new-and-upcoming Country artist and/or a cross-over artist crossing both genres. Simultaneously, the card may provide a discount code to the user related to the above-mentioned artist or genre. Alternatively, if the user informs the device/system that it prefers chocolate over fruit, then the user may be presented with a sample of a chocolate to taste. The user can then sample the chocolate at that time and provide feedback through the dispenser's interface or sample it at a later time. If the user does like the chocolate and provides instant feedback, then the user can be awarded rewards to redeem at a later point in time for products or samples, prompted with a code for purchasing chocolate at a nearby location at a discount, or a survey to fill out and provide feedback to the vendor.

In another preferred embodiment the user may be prompted with a game or a survey, and upon completion, the user may receive a free sample or a digital coupon, which can be sent to the user's email, phone, or mobile application to be redeemed elsewhere. Additionally, and alternatively, the user may have the option to purchase product(s) from the dispenser, whether it is one of the same product(s)/services or similar product(s)/services provided by a competing or similar product provider.

In another embodiment, the dispenser may be located, for instance, at a sports stadium, where the user can purchase, or obtain through playing a game or taking a survey, a vial of dirt from the pitcher's mound if at a baseball stadium, grass from the goal zone at a soccer or football stadium, etc. Upon obtaining the vial, the user may also receive a digital or physical coupon to redeem at the stadium merchandise store or elsewhere, where the discount offered may be dependent on whether the user purchased the vial, played a game, answered a survey, or provided contact information. The vendor providing the dirt/grass and coupons can utilize any information obtained, such as survey data and or contact information to track and understand the user's preferences. For example, if the user answers survey questions stating it prefers chicken wings to fries, lives within five (5) miles of the stadium, claims it does not own any sports paraphernalia, and provides its email address for a coupon, then the user may receive a twenty-five percent discount on merchandise purchased that day rather than ten percent or other variations in line herewith. Then, when the user opts to purchase the merchandise and scans the code, the device/system may identify that the user using the code and track the type of merchandise the user prefers, such as hats to beanies, or tanks to long sleeves. Further, the vendor can provide the data that the user likes chicken wings to restaurants in a five (5) mile radius to the stadium (i.e., location of the dispenser that the user used), to the user's address, or otherwise, and allow the restaurants to send an email to the user encouraging the user to visit the restaurant.

In another embodiment, the user may be prompted with a question about the user's age, gender, and/or other identifying characteristic, and then may be provided the option to choose various styles of clothing and color preferences. Then, using the webcam integral or associated with the device/system, the dispenser may record the user and then show a simulation of suggested clothing on a picture of the user or avatar thereof, in real time at the dispenser and/or email the same to the user or those persons requested by the user's input into the device/system through voice, stylus, or otherwise in communication therewith. The user can select between one to a plurality of options and decide which the user likes as the most desirable. Upon selection, the dispenser can either supply a virtual coupon redeemable to a nearby store for clothing or provide the user with a sample of a product. The vendor can use data provided by the user's selection to identify what styles of clothing are trendy amongst the user's age range and gender.

In another embodiment, the dispenser may be located at a grocery store and contain samples of different flavors, textures, and milk-based options ice creams. The user, after answering several questions based on preferences, is recommended a potential product the user may enjoy. For example, the user may like chocolate ice cream, marshmallow, fudge pieces, and is allergic to milk, then, based on the device/system knowing the user's preferences from previous input, whether saved at the same dispenser or different dispenser located remotely but in communication with a database or storage medium in communication with the instant dispenser, the user is given a small sample of Ben and Jerry's Phish Food Ice Cream, if the user likes the ice cream then the user can either purchase a sample from the dispenser or is prompted with a virtual or physical coupon to purchase the ice cream at a discount.

In another embodiment, the user may be prompted to play a game from their mobile device or online. Then at the end of the game the user may be prompted with a QR code or confirmation number to redeem at a nearby module or can upload their confirmation to its user account. The user can then redeem the confirmation code or QR code for a pre-selected product by the dispenser, a product of their choice, user can defer their code to reward points to be used later, or be prompted with a game or survey to then further into more reward points or a different sample which is picked by the dispenser system using AI and machine learning.

In yet another embodiment, the user may “pay” with a membership card (e.g., Costco) wherein said user may receive a sample or product for no cost or, alternatively, a sample at no cost and a product at a full, discounted or reduced rate. This may be further accomplished wherein an organization (e.g., a baseball or football team) may distribute club cards to members wherein samples or products may be offered at a cost, reduced rate or free.

In another preferred embodiment the user, may utilize a computer/mobile application (“app”), examples Amazon, Sephora, Major League Baseball, National Football League, to receive a free sample, to receive a product (free or at a cost), to be notified of samples or products specific to a consumer and available through the dispensing device, to redeem a virtual coupon for a sample or product or a combination thereof.

In yet another embodiment, the customer may first interact with the device, answering questions or playing a game, which may then prompt the user to either scan a QR code or enter an email. If the user scans a QR code, the user may then be directed to a URL or web address to complete a survey or enter identifying information (e.g., email, phone number, social media credentials, a membership code or a combination thereof) by which to receive information, codes, prompts, notifications, advertisements, pushed information and the like.

If the user enters an email, or other identifying information (above), the user may then be supplied consumer directed information specific to a consumer via email, text, purchasing platform (Amazon®, App Store®, Google Play®) or via social media (Facebook®, Instagram®) page through provided contact information. In opposite, a user may first scan a QR code, which directs a consumer to answer questions, play a game or compete a task whereby a completed set of questions, game or task may direct a user to enter identifying information which, in turn, prompts the device to dispense a sample, a product, a receipt, a card or other fungible or non-fungible tokens which may be redeemed for a physical or virtual product, products, points credits or other like remunerations.

In another embodiment, a single platform (i.e., Amazon®, Google® or the like) may have access to user preferences, prior choices or answered inquires as to better direct advertising, of samples, products or both, when a user utilizes a particular platform. Moreover, this advertising may be prompted through a consumers' smartphone installed applications wherein the application, ex. Amazon®, may recognize the dispensing device or the dispensing device recognizes the installed application (through Wi-Fi® or Bluetooth®) and transmit or otherwise push information (push notices) related to device products harbored within device. Too, the device may be able to query a user's device as to also receive information specific to a particular application where the user may allow the application operator to seek consumer-specific information.

In yet another embodiment, while inventor envisions a cashless transaction (credit/debit cards or digital wallets), devices may be constructed to accept cash and coin in locations where physical representations of monies are necessitated or preferred by consumers. Further, this representation may be evidenced as tokens, coupons, vouchers, real and virtual, which may be currency but serves to “purchase” samples or goods nonetheless.

In another embodiment, a sample may be dispensed in a supermarket along with a coupon or token allowing the consumer to locate, select and purchase a good at a regular or discounted price at checkout.

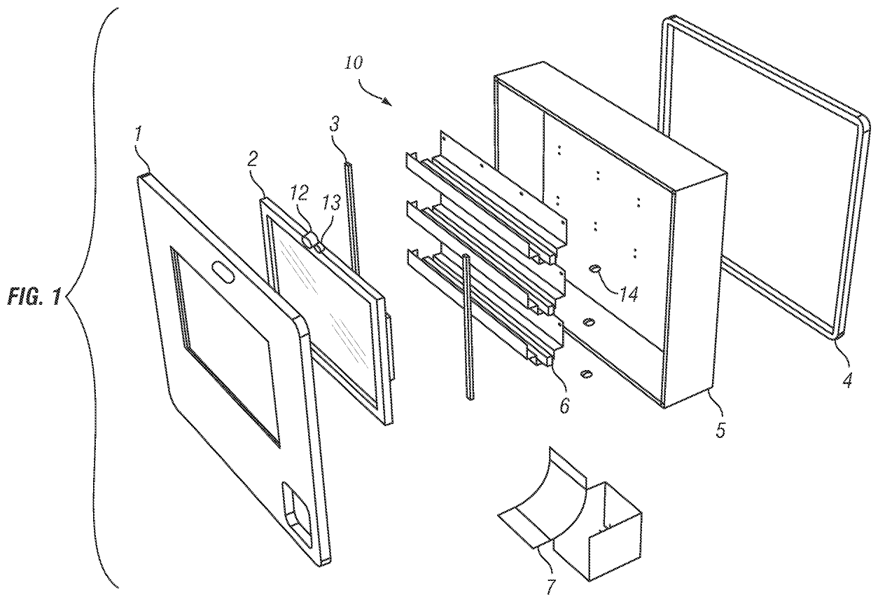

FIG. 1 evidences a module 310 that is a vending device wherein the main housing of the module 310 is comprised of a front face plate 1 which is coupled with a side and back housing 5. Touch screen and graphic user interface (GUI) 2 is mounted within front face plate 1 via side mounts 3 and wherein cartridge(s) 6 are made to run horizontally and housed inside of housing 5. Cartridges 6 are made to connect and communicate with ramp 7 which provides the dispensed product to the user/consumer/customer through a front opening in front face plate 1. Infrared sensors 14 are placed inside of housing 5 in communication with cartridge(s) 6 as to provide a means of detection and monitoring.

Also internally, front camera 12 and human presence detector (sensor) 13 are placed atop touch screen 2 and behind camera opening in front face plate 1.

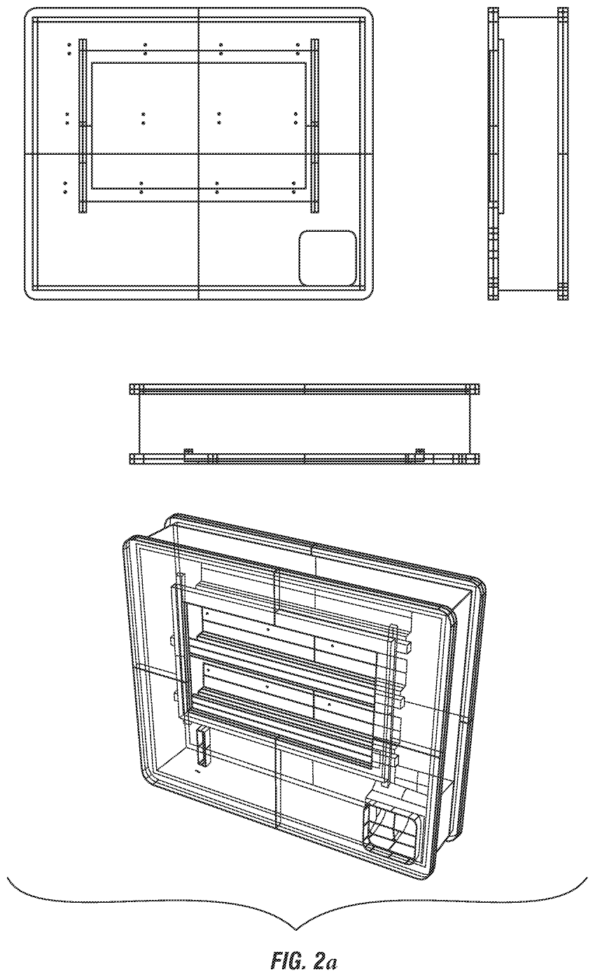

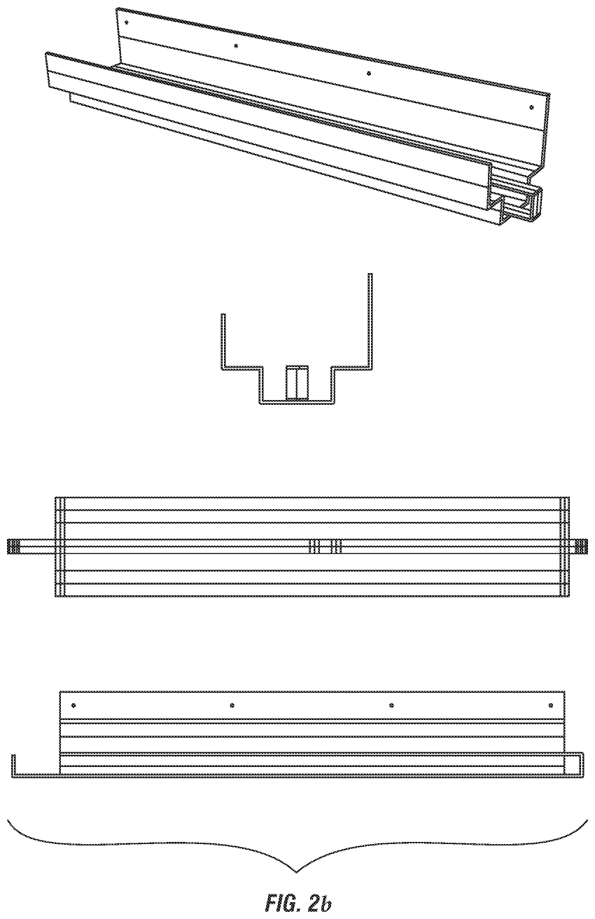

FIG. 2 is a front perspective 8 of the vending device module 10 comprised of screen illustrating the graphic user interface (GUI) 2 for interaction between user (not shown) and module 310 where graphical information is displayed together with front opening x where products may be dispensed.

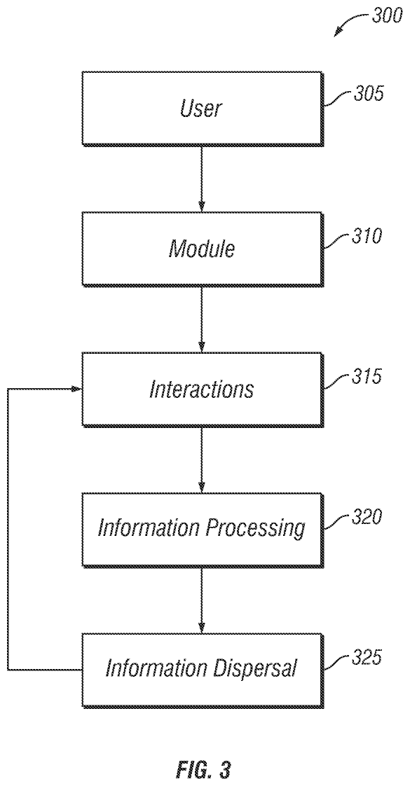

FIG. 3 illustrates an exemplary system 300 for collecting data, assigning the data a value and determining and indicating the value of the user input. As shown in FIG. 3, system 300 begins with user 305 and user 305 interaction 315 with module 310. User 305 interfaces with module 310 wherein module 310 may be comprised of a screen, touch screen, gesture recognition module, human presence detection module, audio recognition detection module, etc., or a combination thereof. User 305, through an interface with module 310, interacts 315 with the system 300, wherein the interaction 315 which can take place through a number of embodiments, whether a combination of interactions or a single interaction 315. Such interactions 315 may be comprised of making a payment, playing a game, scanning a code, inputting direct or indirect identification data, and/or inputting information based on prompted questions thereby receiving product(s) or service(s). Once user 300 completes interaction 315, the inputted information, as well as product and inventory data, are transmitted via a signal from the module 310 to an internal or external data collection repository for information collection and/or information processing 320. The signal, is thereby transmitted for information processing 320 which is comprised of various pieces of information/data (direct, indirect or a product of gamification via the user-module interaction) from the user's 305 interactions 315 with module 310, such as directly inputted information by the user 305 provided while playing games, answering questions, inputting information, providing payment and the like; indirectly provided information from the system 300 during the user 305 interaction 315, such as geographic location, time, etc.; or inventory available in the system 300 provided as a “product” (tangible, intangible or transferable) to the user 305. The information processing 320 then transmits the information/data for information dispersal 325 for collection, monitoring, analysis, identification and processing by the vendor or a third-party processor. Information dispersal 325 is achieved by sending the information directly or indirectly through the operator of the system 300, to a third party, or directly to a vendor, etc., or in a combination thereof, whereby the operator of the system 300 may collect, store, process, analyze and monitor data on behalf of vendor, for internal consumption, for the operator to analyze, process, monitor and/or store or may provide said data in the raw or processed to a third party to further process or discriminate the information/data or to a vendor directly. Information dispersal 325 provides the operator of the system 300, at its discretion, the ability to provide access to a third party or directly a vendor information/data to use for analysis. The data/information provided by user 305 to system 300 permits the interactions 315 presented to the operator to be collected, stored, processed, analyzed and monitored by the operator, a third-party processor or a vendor directly or indirectly, whether the interactions provide information (data) that is direct or indirect and whether the information (data) has been examined or modified by the operator with an end goal of providing to user 305 an enhanced user experience and an end user (vendor) identifying information based on the user 305 interaction with the system as an end result or as a means to gather further user/consumer 305 data.

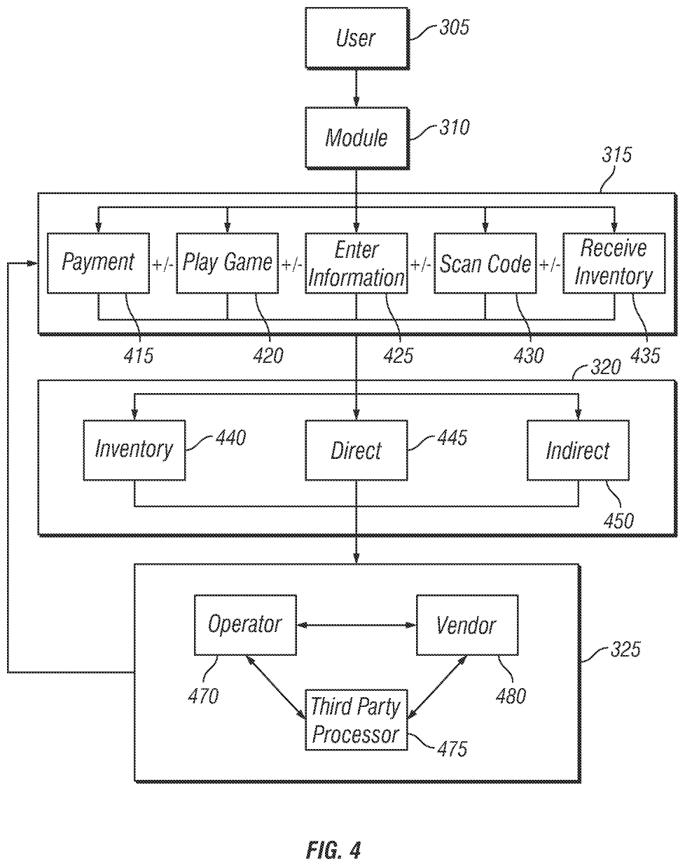

FIG. 4 illustrates an example of system 300 according to this disclosure. System 300 may represent any components 305, 475. In this example, system 300 comprises user 305 that interacts with module 310. Module 310 may be comprised of a screen, touch screen, gesture recognition module, human presence detection module, audio recognition detection module, etc., or a combination thereof. User 305 is prompted with a series of potential interactions 315. User 305 may be attracted to the system 300 by means of sounds, videos, advertising, promotions, free products, etc.

The user 305 then selects one of interactions 315, after completing interaction(s) 315 user 305 is prompted with the choice to select another interaction 315 or terminate the interaction 315 with system 300. For example, in one preferred embodiment user 305, through module 310, selects to enter information 425, play a game 420, and then receive inventory 440. In another preferred embodiment the user 305, through module 310, selects to scan code 430, make payment 415, and then receive inventory 435. In another preferred embodiment, the user 305 decides to enter information 425. In another preferred embodiment, user 305 decides to enter information 425 and/or make payment 415. In another preferred embodiment, the user 305 decides to make a charitable contribution to a charity, the user 305 makes a payment 415 and receives inventory 435 comprising of a charitable tax donation slip, which can be sent to user 305 electronically by entering in prompted contact information 425, loyalty reward points, and a collector's pin. Payment 415 by user 305 can be proffered in a number of ways, such as cash, debit/credit, or other electronic forms of fungible payment. The information 425 entered by user 305 can collect a variety of data/information, such as contact information, various preferences, demographic data, socioeconomics or other identifying indicia material to a manufacturer or retailer as to better define an individual, groups of individuals, groups of groups, or a combination thereof, spanning selected individuals all the way to metadata, etc. The code scanned 430 by user 305 may be comprised of a QR code, inputting a code provided to user 305, etc. Inventory received 435 by user 305 can be provided by a vendor 480, operator 470, or another party to be awarded to user 305 upon selection of received inventory 435 from interaction 315. Received inventory 435 by user 305 may be comprised of tangible items, such as edible and drinkable products, cleaning products, physical coupons, office supplies, figurine, gift cards etc., or intangible items, such as electronic discounts and coupons, reward/loyalty points, electronic gift cards, tax deduction receipts, general information, etc. The interaction 315 initiated by user 305, can be achieved directly on the module 310 or indirectly through a remote device, such as user's mobile device, by scanning a code 430 during interaction 315, forwarding a link from system 300 to user 300 by entering in contact information during interaction 315. After user 305 completes interaction 315 with the system 300 through the module 310, the information/data from the interaction(s) 315 is/are sent for information processing 320.

Information/data sent for information processing 320 is comprised of various information/data from user 305 interactions 315, such as direct 445 inputted information by user 305 that may be provided while playing a game 420, entering information 425, scanning a code 430, etc.; indirectly 450 provided from the system 300 during user 305 interaction 315, such as geographic location, time, etc.; inventory 440 available in the system 300 to provide to user 305 after user 305 has an interaction 315 with the system 300 comprised of receiving inventory 435. The data/information sent for information processing 320 undergoes information dispersal 325. For example, the information processing can then be sent directly to operator 470, to a third-party processor 475, and/or to a vendor 480. In the alternative, the information processing 325 may be transmitted directly to operator 470, to send to a third-party processor 475, which is then sent back to operator 470 which then sends the processed data/information for further information processing 325 or to vendor 480, directly. In another preferred embodiment, information processing 325 may be sent directly to operator 470 and may be also sent directly to third-party processor 475, which then sends the processed data/information from operator 470 after information processing 325, to a vendor 480. In another preferred embodiment, information processing 325 may be sent directly to a third-party processor 475, which then sends the processed data/information from third-party processor 475 to vendor 480. In another preferred embodiment, processed information 325 may be sent directly to the vendor 480, to send to a third-party processor 475, which then sends the processed data/information from the information processing 325 to both the vendor 480 and to operator 470. In another preferred embodiment, information processing 325 may be sent directly to operator 470, which then processes the information 325 whereby data/information is sent from information processing 325 to a vendor 480. Information dispersal 325 provides operator 470, a third-party processor 475, and/or the vendor 480 data/information from information processing 320, which may or may not be processed for various purposes as described above. In another preferred embodiment, the vendor 480 may review the data/information and provides operator 470 with feedback to revise or modify the presentation of interactions 315 presented to user 305, such as revising the game played 420, changing the received inventory 435, and/or modifying the prompted questions to the user 305 when the user 305 is prompted to enter information 425.

Persons skilled in the art will readily understand that these advantages (as well as the advantages indicated in the summary) and objectives of this system are possible without each particular combination of computer hardware, software and/or firmware, based on desired outcome (i.e., tangible versus intangible products), presented interactions, and other structural components and mechanisms assembled in this current invention and described herein. It will be further understood that a plethora of programming tools, known to persons skilled in the art, are available for implementing the control of the features and operations described in the current specification. Moreover, the particular choice of programming tool(s) may be controlled by the specific objectives and constraints placed on the implementation plan selected for realizing implementation of concepts set forth herein.

The present embodiments are therefore to be considered in all respects as illustrative, exemplary and not to be taken as restrictive. Accordingly, the scope of the invention is defined by the appended claims rather than by the foregoing description. All changes which come within the meaning and range of equivalency of the claims are therefore intended to be encompassed herein. Further, each individual element of the claims are not well-understood, routine, or conventional. Instead, the claims are directed to the novel, and non-obvious inventive concept described in the specification.

1. A non-transitory program storage device comprising instructions stored thereon for effectuating an interactive system for gathering data/information from a user, comprising:
a module;
said module comprised of logic;
said logic including hardware, software, firmware or a combination thereof;
said module capable of interfacing, via an interface, said user with quires, a product or products, or a combination thereof, via data entry;
said module displaying interactions, presented on said module, via said interface;
said module collecting and processing data/information based on the user's input;
said user input comprising direct data, indirect data, or a combination thereof;
said module dispensing a product or products based on collected data;
said product is a tangible product, intangible product, a service, or a combination thereof;
collecting such information obtained from the user's interaction;
utilizing the obtained information; and
said system modifying user's interaction with the system.

2. The system of claim 1, wherein the user interacts with the module providing said direct data, indirect data, or a combination thereof, through product purchasing, gamification or reward systems to provide advertising services and consumer-specific data to retailers, brands, vendors and product manufacturers.

3. The system of claim 2 wherein, the interface is comprised of a screen, touch screen, gesture recognition module, human presence detection module, audio recognition detection module, or a combination thereof.

4. The system of claim 3, wherein the module is located at a retail location, grocery store, department store, entertainment or theme park, educational institution, venue or external to a building wherein said system has logic.

5. The system of claim 4, wherein said user is presented with interactions on said module, wherein said user may access interactions via a mobile or portable device, such as making a payment, playing a game, inputting information, scanning a code, receiving inventory, or a combination thereof.

6. The device of claim 5, wherein the interactive system, after the completion of said user's interactions outputs information/data for information processing, comprised of direct information about said user, such as age, gender, contact information, socio-economics and identifying information is combined with preferences of said user, and indirect information, such as geographic location, time, of the module.

7. The device of claim 6, wherein said information is utilized by a module operator, a third-party process, or a vendor to measure user engagement, monitor consumer activity, determine return on investment, to create brand awareness/recognition, and/or to understand purchasing power which is quantifiable demographically.

8. The device of claim 7, wherein the information processing is utilized to modify user interactions presented to the user to provide a feedback loop gather further data, modify queries, or a combination thereof.

9. An interactive method for gathering data/information from a user, comprising:
approaching module by user;
interacting with module by user;
registering, by user, with module software through provision of user-specific information into module;
registration information comprising e-mail, cellular phone, facial recognition, verbally, via a membership card, virtual wallet or through a URL or mobile phone application, or a combination thereof;
prompting, by module, user input of direct information;
direct information comprising phone, email, social media information, age, gender or preferences, or a combination thereof;
answering module prompts, by user;
collecting and processing, by module, direct user information;
integrating indirect information, by module, with indirect user information;
indirect information such as demographic information, location information and socio-economic information; and
customizing products or services offered to a user, through direct and indirect information gathering, to identify, categorize a user to a specific group or demographic to tailor products and services to user.

10. The method of claim 9, wherein said user interacts with said module comprising the steps of:
interacting with said module;
inputting user information;
said information comprised of direct information, indirect information or information gathered from gamification;
receiving a product, service, coupon, rebate, reward or combination thereof reflective of user inputs.

11. The method of claim 10 wherein, said module's data collection means is comprised of a screen, touch screen, gesture recognition module, human presence detection module, audio recognition detection module.

12. The method of claim 11, wherein preferences are used to advertise, customize samples or product samples, products, to provide discounts, rebates or rewards, or a combination thereof.

13. The method of claim 12, wherein the user is presented with interactions which the user may access via a mobile or portable device, to make a payment, play a game, input information, scan a code, receive inventory, or a combination thereof.

14. The method of claim 13, wherein after interactive method is complete said module outputs information/data for information processing, comprised of direct and indirect information, gamification, or a combination thereof, together with available inventory of product available in the system to disperse.

15. The method of claim 14, wherein the information processing is then utilized by Boxes, a third-party process, vendor, to review the information and apply for further application.

16. The method of claim 15, wherein the information processing is utilized to revise the interactions presented to the user, whether custom or generic to a user to enhance the user experience with the system and gather further data.

17. A method of gathering information from a user to advertise products, sample products, sell products, target consumers, collect consumer data, or a combination thereof, through gamification, comprising:
collecting direct information from user through a registration process;
collecting indirect information from user through indirect information;
collecting preference information through gamification;
combining direct information, indirect information and preference information; and
determining likely preferences based on gathered information.

18. The method of claim 17, wherein the interactions prompting said user is provided through a module comprised of a screen, touch screen, gesture recognition module, human presence detection module, audio recognition detection module, and interactions on said module wherein said user may access the interactions via a mobile or portable device to make a payment, play a game, input information, scan a code, receive inventory, or a combination thereof.

19. The method of claim 18, wherein after the completion of the user's interactions module outputs information/data for information processing, comprised of direct information about the user, such as age, gender, contact information, socio-economics or other identifying information, preferences of the user, indirect information, such as geographic location, and time of the module interaction, together with available inventory of product available in the system to disperse.

20. The method of claim 19, wherein the information/data from the information processing is reviewed and analyzed during the information dispersal to revise the interactions prompted to the user, whether generally or custom to a user interaction.
